(19) United States
(12) Patent Application Publication
(10) Pub. No.: US 2020/0355210 A1
(43) Pub. Date: Nov. 12, 2020

(54) FRAME FOR STEEL FURNITURE AND FRAME ASSEMBLY

(71) Applicant: Ha Kyeong KOO, Uijeongbu-si (KR)

(72) Inventor: Ha Kyeong KOO, Uijeongbu-si (KR)

(21) Appl. No.: 16/642,209

(22) PCT Filed: Aug. 21, 2018
(86) PCT No.: PCT/KR2018/009604

§ 371 Date: Feb. 26, 2020

(30) Foreign Application Priority Data
Aug. 28, 2017 (KR) 10-2017-0108617
Sep. 29, 2017 (KR) 10-2017-0127412

(51) Int. Cl. F16B 12/30

(52) U.S. Cl. CPC F16B 12/30; A47B 13/06

(57) ABSTRACT

A frame for steel furniture and a frame assembly, wherein the frame has a simple structure due to having a press groove and a bent bar formed in a hollow bar, is easily assembled through a connecting part or the like, thus greatly reducing manufacturing, installation, and maintenance costs, and can be expanded as in various embodiments. The frame, which is for steel furniture and formed by a hollow rectangular bar, is characterized in that: the corner of the rectangular bar is press-processed by a jig having a predetermined thickness, thereby forming the press groove in two surfaces contacting the corner; the bent bar having an “L”-shape forms inside the hollow rectangular bar while the press groove is being formed; and threads for fastening a fastening screw are formed on one surface of the bent bar, wherein the one surface faces the press groove.

### TECHNICAL FIELD

The present invention relates to a frame for steel furniture and a frame assembly, in which the frame is configured such that a pressed slit and a bent bar are formed at a hollow quadrangular bar and threads are formed by tapping on the bent bar, thereby having a simple structure, being easy to assemble using a fastening screw or the like, thereby significantly reducing manufacturing, installation, and maintenance costs, and being capable of being expanded to various embodiments.

### BACKGROUND ART

Frames constituting the skeleton of steel furniture, such as desks, benches, or showcases, are mainly made of square or circular shaped steel beams. Frames using such steel beams are configured such that vertical bars or horizontal bars are arranged in a cross-direction, so that the frames maintain a circular shape while resisting action of load or external force.

In the frames, a connection structure is essentially required for coupling between the vertical bars and the horizontal bars arranged in the cross-direction. Such a connection structure uses a conventional welding method. For example, in the case of a desk, junctions between vertical bars constituting legs of the desk and horizontal bars coupled to the vertical bars in the cross-direction are welded.

However, when welding is performed on the junctions between the bars, resulting welded areas may be rough and the appearance may be inferior. This may require post-processing, i.e., grinding work, to be performed, leading to a problem that a manufacturing process may be cumbersome and take a lot of time and thus workability may be lowered.

In an effort to solve the above problem, a connector capable of fixing frames of a steel office desk using fixing bolts, without using welding or the like has been proposed in Korean Patent No. 10-1101395, entitled “Frame connector of desk”.

However, the frame connector is problematic in that the connector may be difficult to manufacture, and may be difficult to implement in various forms.

### DISCLOSURE

### Technical Problem

Accordingly, the present invention has been made keeping in mind the above problems occurring in the related art, and an objective of the present invention is to provide a frame for steel furniture and a frame assembly, in which the frame is configured such that a pressed slit and a bent bar are formed at a hollow quadrangular bar and threads are formed by tapping on the bent bar, thereby having a simple structure, being easy to assemble using a fastening screw or the like, thereby significantly reducing manufacturing, installation, and maintenance costs, and being capable of being expanded to various embodiments.

Another objective of the present invention is to provide a frame for steel furniture and a frame assembly, in which a support plate or a fastening ring which can be fastened to a fastening screw is placed inside a hollow quadrangular bar through a pressed slit, and a fastening screw is inserted into the hollow quadrangular bar from outside the bar to be fastened to the support plate or the fastening ring inside the quadrangular bar, thereby making it possible to easily couple the frame according to the present invention and various frame and plate-like objects to be coupled to each other.

### Technical Solution

In order to accomplish the above objective, according to one aspect of the present invention, there is provided a frame for steel furniture,

the frame being configured by a hollow quadrangular bar,

wherein a corner of the quadrangular bar is pressed by a jig having a predetermined thickness to form a pressed slit in two surfaces neighboring to the corner,

an “L”-shaped bent bar is formed inside the hollow quadrangular bar by formation of the pressed slit, and

the bent bar is configured such that threads for fastening a fastening screw are formed on a surface of the bent bar, the surface facing the pressed slit.

According to another aspect of the present invention, there is provided a frame assembly, including:

a first horizontal bar including a fastening hole formed in each of upper and lower surfaces thereof such that the respective fastening holes face each other in up and down directions;

the frame connected to the upper or lower surface of the first horizontal bar at a position of the fastening hole; and

a fastening screw inserted into the frame by being fastened to the fastening hole that is formed in a surface of the first horizontal bar, the surface being opposite to a surface where the frame is provided, and fastened to the bent bar formed inside the quadrangular bar of the frame so as to connect and fix the frame and the first horizontal bar to each other.

According to another aspect of the present invention, there is provided a frame for steel furniture, the frame being configured by a hollow quadrangular bar,

wherein a corner of the quadrangular bar is pressed by a jig having a predetermined thickness to form a pressed slit in two surfaces neighboring to the corner,

an “L”-shaped bent bar is formed inside the hollow quadrangular bar by formation of the pressed slit, and

a nut for fastening a fastening screw is provided inside the quadrangular bar in a space between the bent bar and the pressed slit.

According to another aspect of the present invention, there is provided a frame for steel furniture,

the frame being configured by a hollow quadrangular bar and including:

a pressed slit which is open in a predetermined area in two surfaces neighboring to a corner of the quadrangular bar; and

a fastening screw fitted to a support plate of a predetermined area including a fastening hole, inserted into the pressed slit integrally with the support plate to be positioned inside the quadrangular bar, and fastened to an object to be coupled that is connected to an end of the quadrangular bar while the support plate is supported by the pressed slit.

Furthermore, the frame assembly using the frame may be configured such that a first horizontal bar of a predetermined length in which at least one fastening hole is formed or a fixing plate of a predetermined area in which at least one fastening hole is formed is provided,

the end of the quadrangular bar of the frame is connected to one surface of the first horizontal bar or the fixing plate, and

the fastening screw provided inside the quadrangular bar of the frame is fastened to the fastening hole of the first horizontal bar or the fastening hole of the fixing plate, whereby the first horizontal bar or the fixing plate and the frame are coupled to each other.

### Advantageous Effects

According to the present invention, a pressed slit and a bent bar are formed at a hollow quadrangular bar by pressing, and threads are formed on the bent bar by tapping. Therefore, the present invention provides a simple structure and is easy to fabricate a frame assembly by using a fastening screw or the like, thereby significantly reducing manufacturing, installation, and maintenance costs.

Furthermore, a nut having a thread is provided inside the quadrangular bar between the pressed slit and the bent bar, thereby making it possible to omit a tapping process of the bent bar performed for fastening to the fastening screw, thereby reducing a work time.

Furthermore, through the provision of the pressed slit and the bent bar formed at the quadrangular bar, it is possible to expand the present invention to various embodiments.

Furthermore, according to the present invention, a pressed slit is formed at a hollow quadrangular bar by pressing, and a support plate which can be fastened to a fastening screw and/or an external fastening screw is placed inside the quadrangular bar through the pressed slit. Therefore, the present invention provides a simple structure and is easy to fabricate a frame assembly by using a fastening screw or the like, thereby significantly reducing manufacturing, installation, and maintenance costs.

### DESCRIPTION OF DRAWINGS

FIG. 1 is a schematic view illustrating a frame for steel furniture according to the present invention.

FIG. 2 is an assembly view illustrating an embodiment of a frame assembly using the frame for steel furniture according to the present invention.

FIG. 3 is a schematic view illustrating another embodiment of a frame for steel furniture according to the present invention.

FIG. 4 is an assembly view illustrating another embodiment of a frame assembly using the frame for steel furniture according to the present invention.

FIGS. 5 and 6 are assembly views illustrating another embodiment of a frame assembly according to the present invention.

FIGS. 7 and 8 are schematic views illustrating another embodiment of a frame for steel furniture according to the present invention.

FIGS. 9 and 10 are assembly views each of which illustrates another embodiment of a frame assembly according to the present invention.

FIGS. 11 and 12 are respectively a process view and a schematic view illustrating a frame for steel furniture according to the present invention.

FIG. 13 is a schematic view illustrating another embodiment of a frame for steel furniture according to the present invention.

FIG. 14 is a schematic view illustrating another embodiment of a frame for steel furniture according to the present invention.

FIGS. 15 and 16 are schematic views illustrating another embodiment of a frame for steel furniture according to the present invention.

FIGS. 17 to 29 are schematic views illustrating various embodiments of a frame assembly using a frame for steel furniture according to the present invention.

### BEST MODE

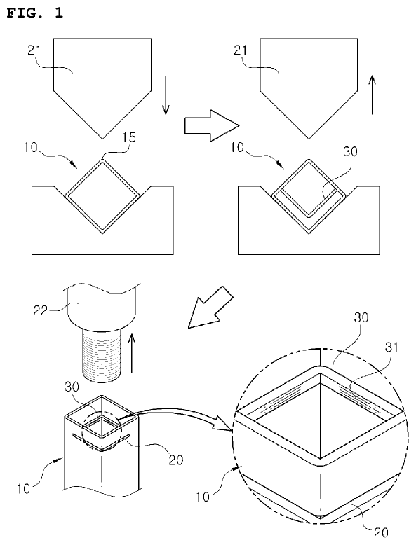

FIG. 1 is a schematic view illustrating a frame for steel furniture according to the present invention.

A frame for steel furniture according to the present invention is configured by a hollow quadrangular bar 10, in which a corner 15 of the quadrangular bar 10 is pressed by a jig 21 having a predetermined thickness to form a pressed slit 20 in two surfaces neighboring to the corner 15, and an “L”-shaped bent bar 30 is formed inside the hollow quadrangular bar 10 by formation of the pressed slit 20.

Although the frame for steel furniture according to the present invention is configured by the hollow quadrangular bar 10, a cross-sectional shape of the frame may vary, for example, a circular, triangular, or pentagonal shape as well as a quadrangular shape. Furthermore, the corners of the quadrangular bar 10 are rounded, and thus hollow bars having various cross-sectional shapes may also be applicable to the present invention.

When the corner 15 of the quadrangular bar 10 is pressed by the jig 21 having a predetermined thickness, the pressed slit 20 is formed in the two surfaces neighboring to the corner 15, and the “L”-shaped bent bar 30 is formed inside the hollow quadrangular bar 10 by formation of the pressed slit 20.

Furthermore, the pressed slit 20 is formed by cutting the two surfaces that come into contact with the jig 21, and a resulting cut end portion is bent to form the “L”-shaped bent bar 30 inside the hollow quadrangular bar 10.

That is, the bent bar 30 is formed in such a manner that: a horizontal portion of the quadrangular bar 10 that comes into contact with the jig 21 is cut; a vertical portion of the quadrangular bar 10 that comes into contact with the jig 21 is bent inwardly of the hollow quadrangular bar 10 to form the “L”-shaped bent bar 30; and the pressed slit 20 is formed over the two surfaces neighboring to the corner 15.

Furthermore, the bent bar 30 has threads 31 formed by tapping on a surface facing the pressed slit 20.

That is, the threads 31 are formed by tapping on each of one side and the other side of a surface of the bent bar 30, which is bent into an “L” shape and faces the pressed slit. Meanwhile, threads may also be formed by tapping on an inner surface of the quadrangular bar 10 at each of locations above and below the pressed slit 20.

By formation of the threads 31 on the bent bar 30, a fastening screw 1 for fastening to the other frame may be fastened to the bent bar 30, and a height adjustment screw (not illustrated) for adjusting the height of the quadrangular bar 10 may be inserted and fastened into the quadrangular bar 10.

Furthermore, the bent bar 30 may has a central bent portion formed in a rounded arc shape, thereby extending a joint surface between the bent bar 30 and the fastening screw 1 such that the fastening screw 1 is firmly fastened to the quadrangular bar 10.

To this end, the bent bar 30 may be press-processed by a jig in which a tip portion is formed in an arc shape to form the central bent portion in an arc shape. Alternatively, after the bent bar is formed in an “L” shape, the central bent portion may be polished or cut to form an arc shape.

The bent bar 30 may be formed in various shapes in which the fastening screw can be fastened in addition to the above-described shape.

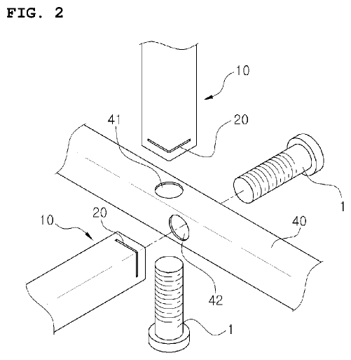

FIG. 2 is an assembly view illustrating an embodiment of a frame assembly using the frame for steel furniture according to the present invention.

A frame assembly according to an embodiment of the present invention includes: a first horizontal bar 40 including a fastening hole 41 formed in each of upper and lower surfaces thereof such that the respective fastening holes face each other in up and down directions; a frame for steel furniture connected to the upper or lower surface of the first horizontal bar 40 with the fastening hole 41 located inside an end of a quadrangular bar 10, and including a bent bar 30 having threads 31 and formed inside the quadrangular bar 10; and a fastening screw 1 inserted into the quadrangular bar 10 by being fastened to the fastening hole 41 that is formed in a surface of the first horizontal bar 40, the surface being opposite to a surface where the frame for steel furniture is provided, and fastened to the bent bar 30 formed inside the frame for steel furniture so as to connect and fix the frame for steel furniture and the first horizontal bar 40 to each other.

Furthermore, a fastening hole 42 is formed in each of front and rear surfaces of the first horizontal bar 40 such that the respective fastening holes face each other in front and rear directions, and the frame for steel furniture is connected and fixed to the first horizontal bar 40 by fastening of the fastening screw 1 and the bent bar 30 on the front or rear surface of the first horizontal bar 40, thereby forming the frame assembly according to the present invention.

Therefore, in the frame assembly according to the present invention, at least two frames for steel furniture may be continuously fixed to one surface of one first horizontal bar 40 by fastening of fastening screws 1 and bent bars 30. Furthermore, the frames for steel furniture may be respectively provided on one surface (upper or lower surface) and the other surface (front or rear surface of the first horizontal bar 40 to cross each other, whereby the frames can be easily assembled by fastening of fastening screws 1.

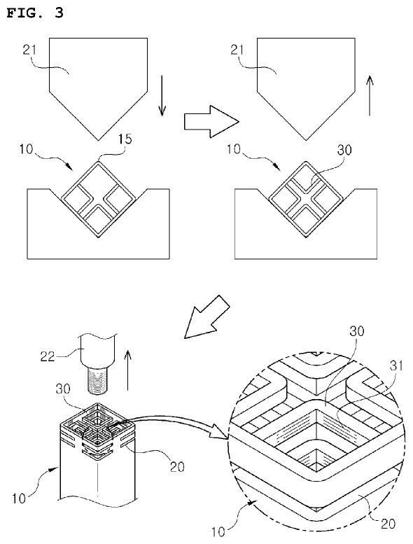

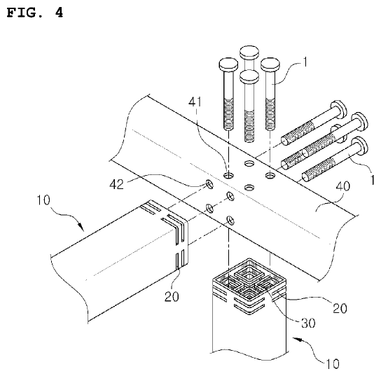

FIGS. 3 and 4 are respectively a schematic view illustrating another embodiment of a frame for steel furniture according to the present invention and an assembly view illustrating another embodiment of a frame assembly using the frame for steel furniture according to the present invention.

A frame for steel furniture according to the present invention is configured by a hollow quadrangular bar 10, in which each of at least two corners 15 of the quadrangular bar 10 diagonally facing each other is pressed by a jig 21 having a predetermined thickness to form a pressed slit 20 in two surfaces neighboring to each of the corners 15, and at least two “L”-shaped bent bars 30 are formed inside the hollow quadrangular bar 10 by formation of the respective pressed slits 20.

Although the frame for steel furniture according to the present invention is configured by the hollow quadrangular bar 10, a cross-sectional shape of the frame may vary, for example, a circular, triangular, or pentagonal shape as well as a quadrangular shape. Furthermore, the corners of the quadrangular bar 10 are rounded, and thus hollow bars having various cross-sectional shapes may also be applicable to the present invention.

Two corners of four corners of the quadrangular bar 10 may be pressed to form the pressed slits 20, the two corners diagonally facing each other, and the four corners of the quadrangular bar 10 may be pressed to form pressed slits 20. The at least two bent bars 30 are formed inside the quadrangular bar 10 by formation of the pressed slits 20.

That is, when the two corners diagonally facing each other among the corners of the quadrangular bar 10 are pressed to form the pressed slits 20, the two bent bars 30 diagonally facing each other are formed inside the quadrangular bar 10. When all the four corners of the quadrangular bar 10 are pressed to form the pressed slits 20, four bent bars 30 are formed inside the quadrangular bar 10.

Furthermore, it is preferable that each of the bent bars 30 is configured such that threads 31 for fastening to a fastening screw 1 are formed by tapping on a surface thereof that faces each of the pressed slits 20, and a central portion thereof bent in an “L” shape is rounded in an arc shape.

As illustrated in FIG. 4, a frame assembly according to another embodiment of the present invention includes: a first horizontal bar 40 including at least two fastening holes 41 formed in each of upper and lower surfaces thereof such that the respective fastening holes face each other in up and down directions; a frame for steel furniture provided at an upper or lower portion of the first horizontal bar 40 such that the at least two fastening holes 41 are located inside an end of a quadrangular bar 10, and including at least two bent bars 30 each of which has threads 31 and formed inside the quadrangular bar 10; and fastening screws 1 inserted into the quadrangular bar 10 by being fastened to the fastening holes 41 that are formed in a surface of the first horizontal bar 40, the surface being opposite to a surface where the frame for steel furniture is provided, and fastened to the bent bars 30 formed inside the frame for steel furniture so as to connect and fix the frame for steel furniture and the first horizontal bar 40 to each other.

Furthermore, fastening holes 42 are formed in each of front and rear surfaces of the first horizontal bar 40 such that the respective fastening holes face each other in front and rear directions, and the frame for steel furniture is connected and fixed to the first horizontal bar 40 by fastening of the at least two fastening screws 1 on the front or rear surface of the first horizontal bar 40, thereby forming the frame assembly according to the present invention.

Therefore, in the frame assembly according to the present invention, at least two frames for steel furniture may be continuously fixed to one surface of one first horizontal bar 40 by fastening of fastening screws 1 and bent bars 30. Furthermore, the at least two frames for steel furniture may be respectively provided on one surface (upper or lower surface) and the other surface (front or rear surface of the first horizontal bar 40 to cross each other, whereby the frames can be easily assembled by fastening of fastening screws 1.

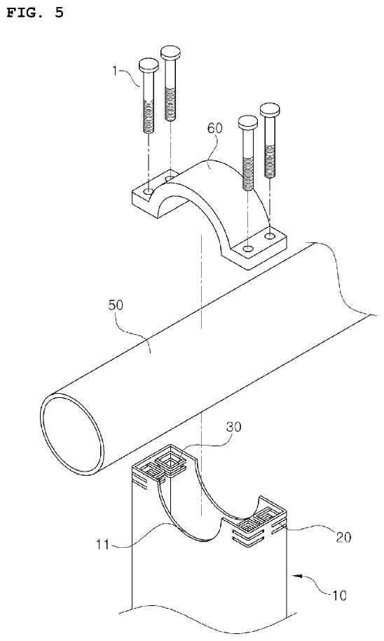

FIGS. 5 and 6 are assembly views illustrating another embodiment of a frame assembly according to the present invention.

First, a frame assembly according to the present invention includes: a frame for steel furniture including at least two bent bars 30 formed inside a quadrangular bar 10 to diagonally facing each other; a second horizontal bar 50 provided at one end of the quadrangular bar 10 in a direction of crossing the quadrangular bar; and a fixing piece 60 connected to the one end of the quadrangular bar 10 of the frame for steel furniture while surrounding an outside of the second horizontal bar 50, and fixing the second horizontal bar 50 to the frame for steel furniture using a fastening screw 1 that is fastened to each of opposite ends of the fixing piece and is inserted into the quadrangular bar 10 of the frame for steel furniture so as to be fastened to each of the bent bars 30.

The frame for steel furniture is configured by a hollow quadrangular bar 10, in which each of four corner 15 of the quadrangular bar 10 is pressed by a jig 21 having a predetermined thickness to form a pressed slit 20 in two surfaces neighboring to each of the corners 15, and four “L”-shaped bent bar 30 are formed inside the hollow quadrangular bar 10 by formation of the respective pressed slits 20.

Furthermore, each of the bent bars 30 is configured such that threads 31 are formed by tapping on a surface thereof, and a central portion thereof bent in an “L” shape is rounded in an arc shape.

Furthermore, the second horizontal bar 50 having a predetermined length is provided an upper end of the quadrangular bar 10 of the frame for steel furniture to cross the quadrangular bar in a horizontal direction. The second horizontal bar 60 passes through the fixing piece 60 fixed to one end of the quadrangular bar 10 while surrounding the outside thereof externally exposed. At least two fastening screws 1 fastened to the opposite ends of the fixing piece 60 are fastened to the bent bars 30 formed inside the quadrangular bar 10, whereby the second horizontal bar 60 is fixed to the frame for steel furniture.

The fixing piece 60 has a central portion formed in a shape conforming to a cross-sectional shape of the second horizontal bar 50, so that the fixing piece surrounds an upper side of the second horizontal bar 50 seated on the quadrangular bar 10 and externally exposed, with the opposite ends thereof seated on an upper portion of the quadrangular bar 10 of the frame for steel furniture. The fastening screws 1 are fastened to fastening holes formed at the opposite ends of the fixing piece and are inserted into the quadrangular bar 10 of the frame for steel furniture so as to be fastened to the bent bars 30.

Therefore, in the frame assembly according to another embodiment of the present invention, when the second horizontal bar 50 of a predetermined length is assembled and fastened to the frame for steel furniture, this can be realized by the fixing piece 60 that is simply and easily fastened to the frame for steel furniture by the fastening screws 1 while surrounding the second horizontal bar 50.

Furthermore, seat grooves 11 conforming to a cross-sectional shape of the second horizontal bar 50 may be formed at an end of the quadrangular bar 10 of the frame for steel furniture where the second horizontal bar 50 is fastened, whereby the second horizontal bar 51 and the frame for steel furniture can be fastened more stably and firmly when the second horizontal bar 50 and the frame for steel furniture are assembled.

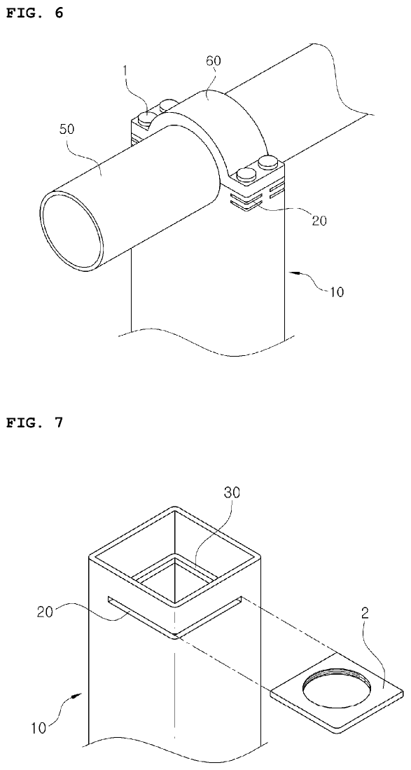

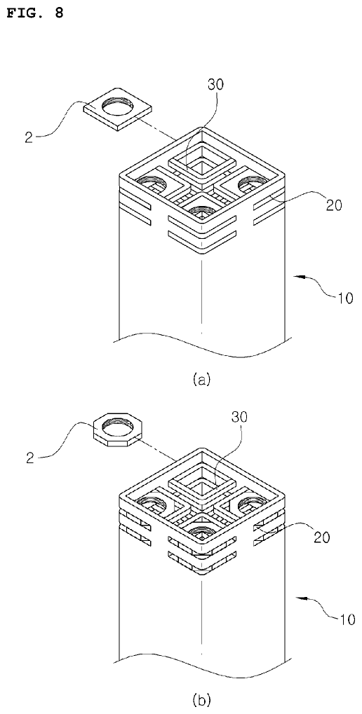

FIGS. 7 and 8 are schematic views illustrating another embodiment of a frame for steel furniture according to the present invention.

A frame for steel furniture according to another embodiment of the present invention is configured such that a corner 15 of a hollow quadrangular bar 10 is pressed by a jig 21 having a predetermined thickness to form a pressed slit 20 in two surfaces neighboring to the corner 15, an “L”-shaped bent bar 30 is formed inside the hollow quadrangular bar 10 by formation of the pressed slit 20, and a nut 2 for fastening a fastening screw 1 is provided inside the quadrangular bar 10 in a space between the bent bar 30 and the pressed slit 20.

That is, by provision of the nut 2 without forming threads for fastening the fastening screw 1 on a surface of the bent bar 30, there is a remarkable effect in that a tapping process for forming the threads is omitted and thus a work time can be shortened.

The nut 2 is provided inside the quadrangular bar 10 in the space between the bent bar 30 and the pressed slit 20, and it is preferable to use a quadrangular or octagonal nut. However, nuts of various shapes may be used depending on the shape of the bent bar 30 or the shape of the space between the bent bar 30 and the pressed slit 20 in an inside of the quadrangular bar 10.

Furthermore, the nut 2 may be forcibly fitted to an inner space of the quadrangular bar 10 through the pressed slit 20 to be fixed with an end thereof seated in the pressed slit 20 and then be fastened to the fastening screw 1, and the end of the nut may be fixed to the pressed slit 20 by welding.

Furthermore, in the frame for steel furniture according to the present invention, four pressed slits 20 are formed in the hollow quadrangular bar 10, four bent bars 30 are formed by formation of the pressed slits 20, and four nuts 2 are provided between the four pressed slits 20 and the four bent bars 30, respectively.

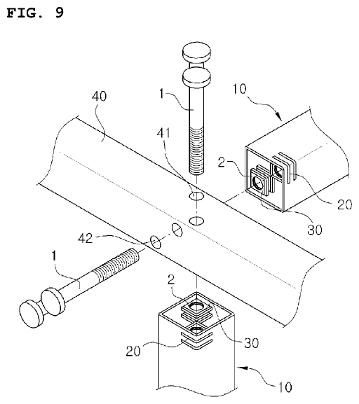

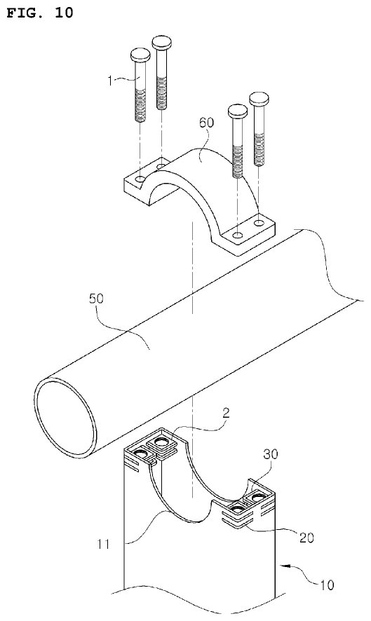

FIGS. 9 and 10 are assembly views each of which illustrates another embodiment of a frame assembly using the frame for steel furniture in which a nut is provided inside the quadrangular bar as described above.

A frame assembly according to another embodiment of the present invention includes: a first horizontal bar 40 including at least two fastening holes 41 formed in each of upper and lower surfaces thereof such that the respective fastening holes face each other in up and down directions; a frame for steel furniture provided at an upper or lower portion of the first horizontal bar 40 such that the at least two fastening holes 41 are located inside an end of a quadrangular bar 10, and including nuts 2 each of which is provided between a pressed slit 2 and a bent bar 30 in an inside of the quadrangular bar 10; and fastening screws 1 inserted into the quadrangular bar 10 by being fastened to the fastening holes 41 that are formed in a surface of the first horizontal bar 40, the surface being opposite to a surface where the frame for steel furniture is provided, and fastened to the nuts 2 provided inside the quadrangular bar 10 of the frame for steel furniture so as to connect and fix the frame for steel furniture and the first horizontal bar 40 to each other.

Furthermore, fastening holes 42 are formed in each of front and rear surfaces of the first horizontal bar 40 such that the respective fastening holes face each other in front and rear directions, and the frame for steel furniture is connected and fixed to the first horizontal bar 40 by fastening of the at least two fastening screws 1 on the front or rear surface of the first horizontal bar 40, thereby forming the frame assembly according to the present invention.

Therefore, in the frame assembly according to the present invention, at least two frames for steel furniture may be continuously fixed to one surface of one first horizontal bar 40 by fastening of fastening screws 1 and nuts 2. Furthermore, the at least two frames for steel furniture may be respectively provided on one surface (upper or lower surface) and the other surface (front or rear surface of the first horizontal bar 40 to cross each other, whereby the frames can be easily assembled.

Furthermore, a frame assembly according to another embodiment the present invention includes: a second horizontal bar 50 provided at an end of a frame for steel furniture in a direction of crossing the frame; and a fixing piece 60 connected to the end of the frame for steel furniture while surrounding an outside of the second horizontal bar 50, and fixing the second horizontal bar 50 to the frame for steel furniture using a fastening screw 1 that is fastened to each of opposite ends of the fixing piece and is inserted into a quadrangular bar 10 of the frame for steel furniture so as to be fastened to each of nuts 2 provided inside the quadrangular bar 10.

Therefore, in the frame assembly according to another embodiment of the present invention, when the second horizontal bar 50 of a predetermined length is assembled to the frame for steel furniture, this can be realized by the fixing piece 60 that is simply and easily fastened to the frame for steel furniture while surrounding the second horizontal bar 50 by fastening of the fastening screws 1 and the nuts 2. This makes it possible to obtain an effect of easily assembling the second horizontal bar 50 to the frame for steel furniture.

Furthermore, seat grooves 11 conforming to a cross-sectional shape of the second horizontal bar 50 may be formed at an end of the quadrangular bar 10 of the frame for steel furniture where the second horizontal bar 50 is fastened, whereby the second horizontal bar 50 and the frame for steel furniture can be fastened more stably and firmly when the second horizontal bar 50 and the frame for steel furniture are assembled.

Meanwhile, a frame for steel furniture according to another embodiment of the present invention is configured by a hollow quadrangular bar 10, in which each of at least two corners 15 of the quadrangular bar 10 diagonally facing each other is pressed by a jig 21 having a predetermined thickness to form a pressed slit 20 in two surfaces neighboring to each of the corners 15, and at least two “L”-shaped bent bars 30 are formed inside the hollow quadrangular bar 10 by formation of the respective pressed slits 20.

Furthermore, at least one pressed slit 20 and at least one bent bar 30 may be further formed above or below each of the pressed slits 20 and each of the bent bars 30, respectively.

Each of the bent bars 30 may be configured such that threads 31 for fastening a fastening screw 1 are formed on a surface thereof by tapping. Alternatively, a nut 2 may be provided inside the quadrangular bar 10 in a space between each of the pressed slits 20 and each of the bent bars 30.

### MODE FOR INVENTION

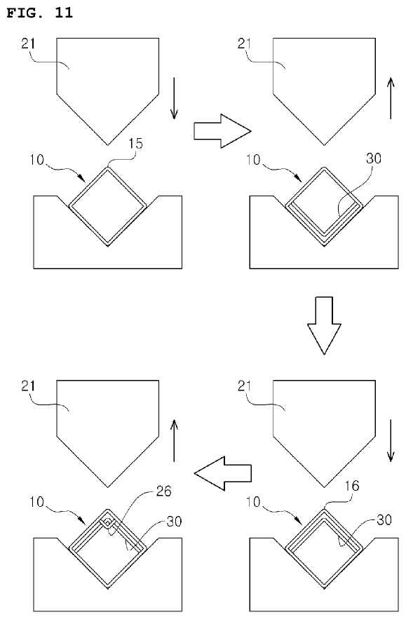

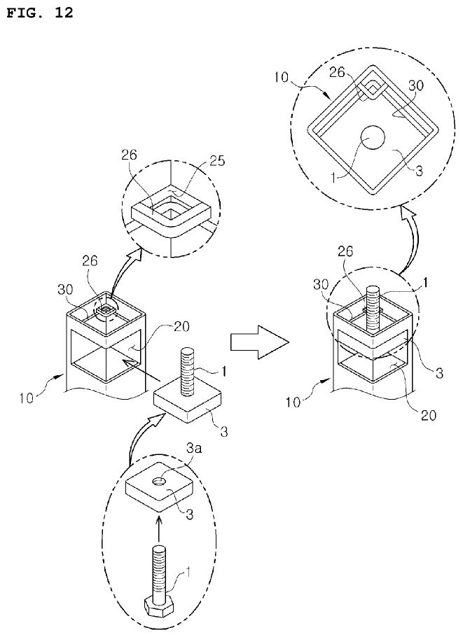

FIGS. 11 and 12 are respectively a process view and a schematic view illustrating another embodiment of a frame for steel furniture according to the present invention.

A frame for steel furniture according to the present invention is configured by a hollow quadrangular bar 10, in which a pressed slit 20 which is open in a predetermined area is formed in two surfaces neighboring to at least one corner 15 of the quadrangular bar 10.

Although the frame for steel furniture according to the present invention is configured by the hollow quadrangular bar 10, a cross-sectional shape of the frame may vary, for example, a circular, triangular, or pentagonal shape as well as a quadrangular shape. Furthermore, the corners of the quadrangular bar 10 are rounded, and thus hollow bars having various cross-sectional shapes may also be applicable to the present invention.

The pressed slit 20 may be formed by punching, cutting, or pressing. Preferably, pressing may be performed using a jig 21 having a predetermined thickness to form the pressed slit 20 in the two surfaces neighboring to the corner 15.

The quadrangular bar 10 is provided therein with a support plate 3 of a predetermined area having a fastening hole 3a, and a fastening screw 1 fitted into the fastening hole 3a of the support plate 3 and inserted into the pressed slit 20 integrally with the support plate 3 to be positioned inside the quadrangular bar 10.

The support plate 3 is formed to have a width equal to or slightly larger than a cross-sectional width of the quadrangular bar 10 so that when the support plate 3 is inserted into the quadrangular bar 10, an end of the support plate is seated on and supported by an inner edge of the pressed slit 20.

Furthermore, the fastening screw 1 having a quadrangular or hexagonal head is coupled to the support plate 3 by being fitted into the fastening hole 3a formed in a central portion of the support plate 3, and the fastening screw is integrally inserted into the pressed slit 20 in a state in which the fastening screw 1 and the support plate 3 are coupled to each other and is positioned inside the quadrangular bar 10.

The fastening hole 3a of the support plate 3 may have a thread such that the fastening screw 1 is fastened to the fastening hole while passing therethrough, and may be formed as a general through-hole without a thread.

Therefore, in the present invention, when an object to be coupled, such as another bar of a predetermined length or a plate of a predetermined area, is coupled to an end of the quadrangular bar 10, the fastening screw 1 and the support plate 3 are inserted into the quadrangular bar through the pressed slit 2 in a state in which the objected to be coupled to the quadrangular bar 10 is brought into close contact with the end of the quadrangular bar 10, and the fastening screw 1 is fastened to the object to be coupled by rotating the head of the fastening screw 1 by means of a spanner or a pliers through the pressed slit 20 such that a distal end of the fastening screw 1 is fastened to the object to be coupled, whereby the quadrangular bar 10 is simply coupled to the object to be coupled.

Furthermore, a corner 16 of the quadrangular bar 10 diagonally facing the corner 15 in which the pressed slit 20 is formed is pressed by the jig 21 having a predetermined thickness to form a reinforcement slit 25 in two surfaces neighboring to the corner 16, and an “L”-shaped reinforcement bar 26 is formed inside the quadrangular bar 10 by formation of the reinforcement slit 25.

The reinforcement slit 25 and the reinforcement bar 26 are located not to overlap with the position of the pressed slit 20, and are formed such that a lower boundary portion of the reinforcement slit 25 is located at an upper boundary portion of the pressed slit 20 in a state in which the quadrangular bar 10 is erected. Due thereto, upper surfaces of an end and the other end of the support plate 3 that is inserted into the pressed slit 20 to be provided inside the quadrangular bar 10 are supported by the pressed slit 20 and the reinforcement bar 26.

That is, when the fastening screw 1 is fastened to the object to be coupled to an end of the quadrangular bar 10, the fastening screw 1 provided inside the quadrangular bar 10 is fastened to the objected to be coupled by being pressurizedly rotated in a direction of the end of the quadrangular bar 10. Herein, the fastening screw 1 is rotated in a state in which opposite ends of the support plate 3 are seated on the reinforcement slit 25 and the pressed slit 20 so as not to move in a direction of the object to be coupled.

Furthermore, in a frame assembly according to the present invention, at least two frames for steel furniture may be coupled to one first horizontal bar 40 by fastening of fastening screws 1 and bent bars 30. Furthermore, the frames for steel furniture may be placed on front or rear and upper or lower surfaces of the first horizontal bar 40 such that the frames cross each other, whereby the frames can be easily assembled by fastening of fastening screws 1.

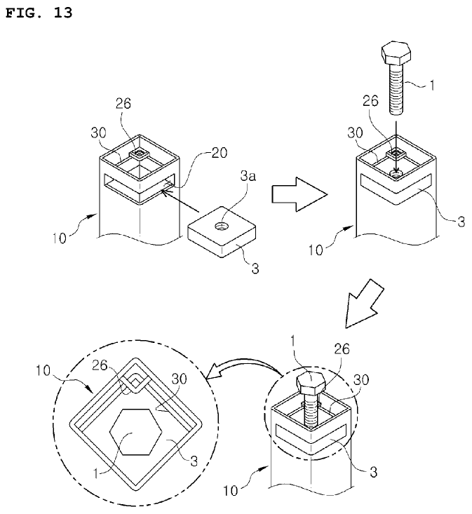

Next, FIG. 13 is a schematic view illustrating another embodiment of a frame for steel furniture according to the present invention.

A support plate 3 is inserted into a pressed slit 20 in a state in which the support plate 3 and a fastening screw 1 are separated from each other, and the fastening screw 1 is inserted into a quadrangular bar 10 from outside an end of the quadrangular bar 10 whereby the fastening screw 1 is fastened to a fastening hole 3a of the support plate 3.

In one example, an object to be coupled, such as a hollow bar of a predetermined length or a plate of a predetermined area, is connected to an end of the quadrangular bar 10, the support plate 3 is inserted into the pressed slit 20 and positioned inside the quadrangular bar 10, and the fastening screw 1 is passed through the object to be coupled and the fastening screw 1 is inserted into the quadrangular bar 10 to be fastened to the fastening hole 3a of the support plate 3 inside the quadrangular bar 10.

That is, the object to be coupled can be easily coupled to an end of the quadrangular bar 10 by fastening of the fastening screw 1, which is passed through (or fastened to) the object to be coupled, and the support plate 3 provided inside the quadrangular bar 10.

Furthermore, when the pressed slit 20 is formed by pressing using a jig 21 having a predetermined thickness, an “L”-shaped bent bar 30 is formed inside the quadrangular bar by formation of the pressed slit. The support plate 3 is located inside the quadrangular bar 10 in a space between the bent bar 30 and the pressed slit 20. Preferably, the support plate 3 may be formed in a circular, quadrangular, or octagonal shape. However, support plates of various shapes may be used depending on the shape of the bent bar 30 or the shape of the space between the bent bar 30 and the pressed slit 20 in an inside of the quadrangular bar 10.

Furthermore, the support plate 3 may be inserted to an inner space of the quadrangular bar 10 through the pressed slit 20 to be fixed with an end thereof forcibly fitted into the pressed slit 20, and the end of the support plate may be fixed to the pressed slit 20 by welding.

Furthermore, in the frame for steel furniture according to the present invention, four pressed slits 20 may be formed at respective corners of the hollow quadrangular bar 10, four bent bars 30 may be formed by formation of the pressed slits 20, and four support plates 3 may be provided between the four pressed slits 20 and the four bent bars 30, respectively.

Furthermore, a corner 16 of the quadrangular bar 10 diagonally facing a corner 15 in which the pressed slit 20 is formed is pressed by the jig 21 having a predetermined thickness to form a reinforcement slit 25 in two surfaces neighboring to the corner 16, and an “L”-shaped reinforcement bar 26 is formed inside the quadrangular bar 10 by formation of the reinforcement slit 25.

The reinforcement slit 25 and the reinforcement bar 26 are located not to overlap with the position of the pressed slit 20, and are formed such that a lower (or upper) boundary portion of the reinforcement slit 25 is located at an upper (or lower) boundary portion of the pressed slit 20 in a state in which the quadrangular bar 10 is erected. Due thereto, surfaces of an end and the other end of the support plate 3 that is inserted into the pressed slit 20 to be provided inside the quadrangular bar 10 are supported by the pressed slit 20 and the reinforcement bar 26.

The support plate 3 is formed to have a thickness equal to or smaller than an open vertical length (height) of the pressed slit 20. When the support plate 3 is formed to have the same thickness as the pressed slit, the support plate 3 is forcibly fitted into the pressed slit 20 and is fixed inside the quadrangular bar 10 while being supported by the reinforcement bar 26 and the pressed slit 20.

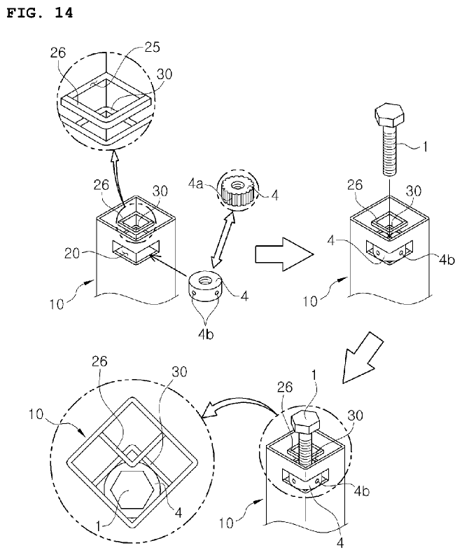

Next, FIG. 14 is a schematic view illustrating another embodiment of a frame for steel furniture according to the present invention.

A frame for steel furniture according to another embodiment of the present invention is configured such that a corner 15 of a hollow quadrangular bar 10 is pressed by a jig 21 having a predetermined thickness to form a pressed slit 20 in two surfaces neighboring to the corner 15, an “L”-shaped bent bar 30 is formed inside the hollow quadrangular bar 10 by formation of the pressed slit 20, and a fastening ring 4 having a predetermined radius is inserted into the pressed slit 20 so as to be provided inside the quadrangular bar 10.

A fastening screw 1 is inserted into the hollow quadrangular bar 10 from outside an end of the quadrangular bar 10 and fastened to the fastening ring 4.

The fastening ring 4 has a hollow inside portion having a predetermined radius, and is configured such that a thread for fastening the fastening screw 1 is formed on an inner surface thereof, and non-slip grooves 4a or at least one fitting hole 4b is formed on an outer circumference thereof.

When an object to be coupled, such as a hollow bar of a predetermined length or a plate of a predetermined area, is connected to an end of the quadrangular bar 10, the fastening ring 4 is inserted into the pressed slit 20 so that the fastening ring 4 is positioned inside the quadrangular bar 10, and the fastening screw 1 is passed through the object to be coupled and the fastening screw 1 is inserted into the quadrangular bar 10 to be fastened to the fastening ring 4 inside the quadrangular bar 10.

That is, the object to be coupled can be easily coupled to an end of the quadrangular bar 10 by fastening of the fastening screw 1, which is passed through (or fastened to) the object to be coupled, and the fastening ring 4 provided inside the quadrangular bar 10.

After the fastening screw 1 and the fastening ring 4 are engaged, the fastening ring 4 is rotated by hand, or the fastening ring 4 is rotated and tightened by a pin or a wrench that is fitted into the fitting hole 4b of the fastening ring 4, thereby securing fastening to the fastening screw 1.

The non-slip grooves 4a for preventing the hand from slipping when the fastening ring 4 is rotated by the hand are formed in the outer surface of the fastening ring 4 in a direction crossing a direction in which the fastening ring 4 is rotated.

Furthermore, the fastening ring 4 is forcibly fitted to an inner space of the quadrangular bar 10 through the pressed slit 20 to be fixed with an end thereof seated in the pressed slit 20 and then is fastened to the fastening screw 1.

Furthermore, in the frame for steel furniture according to the present invention, four pressed slits 20 may be formed at respective corners of the hollow quadrangular bar 10, four bent bars 30 may be formed by formation of the pressed slits 20, and four fastening rings 4 may be provided between the four pressed slits 20 and the four bent bars 30, respectively.

Furthermore, a corner 16 of the quadrangular bar 10 diagonally facing the corner 15 in which the pressed slit 20 is formed is pressed by the jig 21 having a predetermined thickness to form a reinforcement slit 25 in two surfaces neighboring to the corner 16, and an “L”-shaped reinforcement bar 26 is formed inside the quadrangular bar 10 by formation of the reinforcement slit 25. Due thereto, surfaces of an end and the other end of the fastening ring 4 that is inserted into the pressed slit 20 to be provided inside the quadrangular bar 10 are supported by the pressed slit 20 and the reinforcement bar 26.

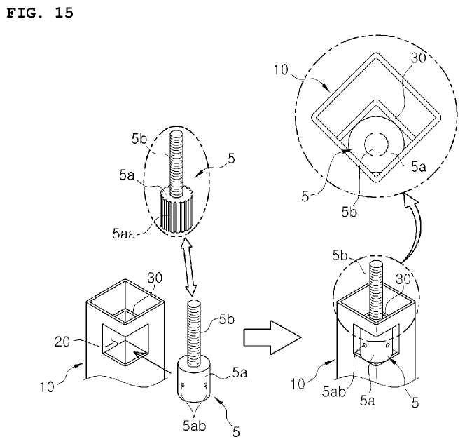

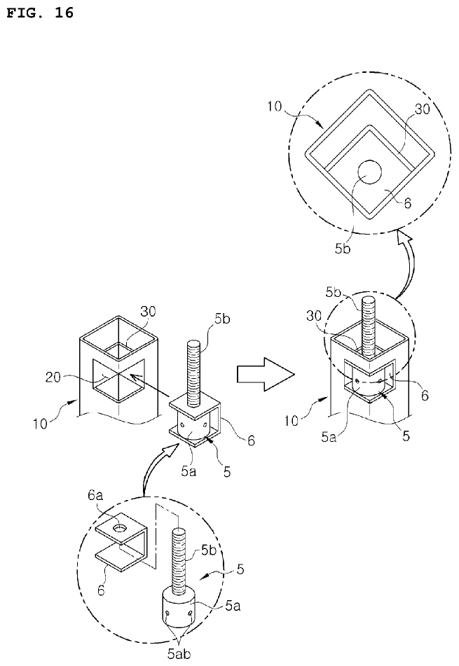

Next, FIGS. 15 and 16 are schematic views illustrating another embodiment of a frame for steel furniture according to the present invention.

A frame for steel furniture according to the present invention is configured by a hollow quadrangular bar 10, and includes: a pressed slit 20 which is open in a predetermined area in two surfaces neighboring to a corner 15 of the quadrangular bar 10; and a screw 5 including a body portion 5a of a predetermined volume and a fastening portion 5b of a predetermined length provided at one side of the body portion 5a and having a thread, inserted into the pressed slit 20 to be positioned inside the quadrangular bar 10, and configured such that the fastening portion 5b is fastened to an object to be coupled that is connected to an end of the quadrangular bar 10 while the body portion 5a is supported by the pressed slit 20.

The screw 5 includes the body portion 5a formed in a cylindrical or polygonal tubular shape, and the fastening portion 5b of a predetermined length provided at one side of the body portion 5a and having the thread.

The screw 5 may be formed in a shape of a syringe, and may be configured such that the body portion 5a thereof is smaller in height than the pressed slit 20 so as to be easily inserted into the pressed slit 20, and the fastening portion 5b thereof extends from the body portion 5a to be integrally formed therewith or is formed to be separately coupled to the body portion 5a.

Furthermore, as illustrated in FIG. 16, the frame for steel furniture according to the present invention further includes: a fixing bracket 6 formed in a “U” shape with three open sides or a hexahedral shape with one open side so that the body portion 5a of the screw 5 is located therein, including a through-hole 6a formed in an upper surface thereof and through which the fastening portion 5b of the screw 5 protrudes, and forcibly fitted into the pressed slit 20 such that an open end thereof is supported by an inner edge of the pressed slit 20.

That is, the fixing bracket 6 is forcibly fitted into the pressed slit 20 such that an end thereof is supported by the pressed slit 20 inside the quadrangular bar 10, and the screw 5 is inserted into the fixing bracket 6 to be positioned therein. Herein, the fastening portion 5b of the screw 5 passes through the through-hole 6a formed in the upper surface of the fixing bracket 6 and protrudes in a direction of an end of the quadrangular bar 10.

Furthermore, vertical non-slip grooves 5aa or at least one fitting hole 5ab is formed in an outer surface of the body portion 5a of the screw 5.

When an object to be coupled, such as a hollow bar of a predetermined length or a plate of a predetermined area, is connected to an end of the quadrangular bar 10, the object to be coupled is provided at the end of the quadrangular bar 10, the screw 5 is inserted into the pressed slit 20 so that the screw 5 is positioned inside the quadrangular bar 10 or the screw 5 is fastened to the fixing bracket 6 so that the fixing bracket 6 and the screw 5 are integrally inserted into the pressed slit 20 to be positioned inside the quadrangular bar 10, and the body portion 5a of the screw 5 is rotated to allow the fastening portion 5b to be fastened to the object to be coupled, whereby the quadrangular bar 10 according to the present invention can be easily coupled to the object to be coupled.

Furthermore, since the vertical non-slip grooves 5aa or the at least one fitting hole 5ab is formed in the outer surface of the body portion 5a of the screw 5, the body portion 5a is rotated by hand, or the body portion 5a is rotated and tightened by a thin rod or a wrench that is fitted into the fitting hole 5ab, thereby securing fastening of the screw 5 and the object to be coupled.

The non-slip grooves 5aa for preventing the hand from slipping when the body portion 5a is rotated by the hand are formed in the outer surface of the screw 5 in a direction crossing a direction in which the body portion 5a is rotated.

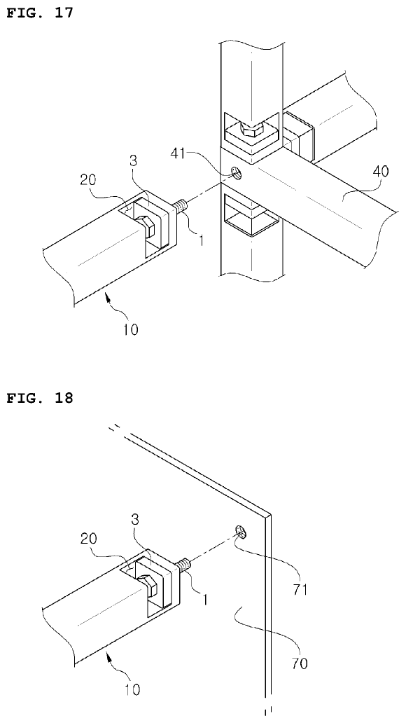

Next, FIGS. 17 and 18 are schematic views illustrating an embodiment of a frame assembly using a frame for steel furniture according to the present invention.

A frame assembly according to an embodiment of the present invention is configured such that a first horizontal bar 40 of a predetermined length in which at least one fastening hole 41 is formed is provided, and an end of a quadrangular bar 10 of a frame for steel furniture is coupled to one surface of the first horizontal bar 40 while surrounding the fastening hole 41.

Herein, a frame for steel furniture includes: a pressed slit 20 which is open in a predetermined area in two surfaces neighboring to a corner 15 of the quadrangular bar 10; and a fastening screw 1 fitted to a support plate 3 having a fastening hole 3a, inserted into the pressed slit integrally with the support plate 3 to be positioned inside the quadrangular bar 10, and fastened to the first horizontal bar 40 connected to an end of the quadrangular bar 10 while the support plate 3 is supported by the pressed slit 20.

Therefore, in the frame assembly according to an embodiment of the present invention, the fastening screw 1 provided inside the quadrangular bar 10 is fastened to the fastening hole 41 formed in one surface of the first horizontal bar 40 so that the first horizontal bar 40 and the frame for steel furniture are coupled to each other.

Furthermore, the frame assembly according to the embodiment of the present invention may be configured such that a fixing plate 70 of a predetermined area in which at least one fastening hole 71 is formed is coupled to the quadrangular bar 10. An end of the quadrangular bar 10 of the frame for steel furniture is connected to one surface of the fixing plate 70 while surrounding the fastening hole 71, and the fastening screw 1 provided inside the quadrangular bar 10 is fastened to the fastening hole 71 of the fixing plate 70, whereby the quadrangular bar 10 of the frame for steel furniture and the fixing plate 70 can be easily coupled to each other.

After the fastening screw 1 is fastened to or passed through the fastening hole 71 of the fixing plate 70, a nut may be fastened to a distal end of the fastening screw 1 protruding rearwardly of the fixing plate 70 to facilitate fastening.

Therefore, by providing a plurality of frames for steel furniture according to the present invention, and by assembling and fastening the frames to each other, it is possible to configure frame assemblies of various shapes.

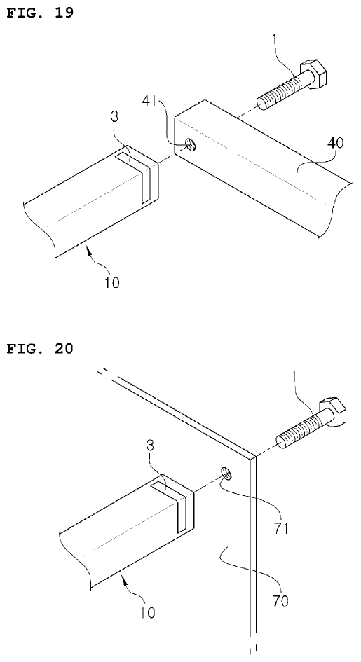

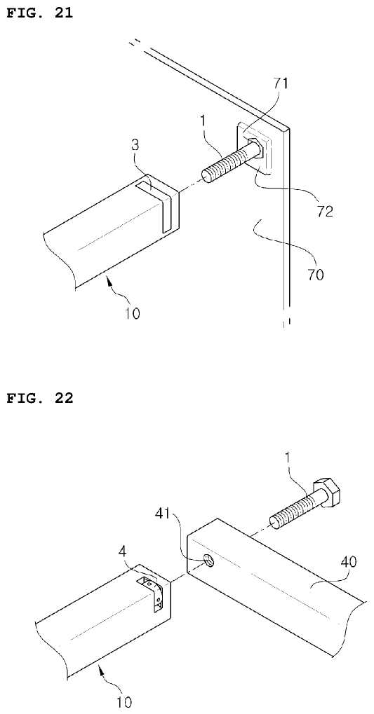

Next, FIGS. 19 to 21 are schematic views illustrating another embodiment of a frame assembly using a frame for steel furniture according to another embodiment the present invention.

A frame assembly according to an embodiment of the present invention includes a hollow first horizontal bar 40 in which at least one fastening hole 41 is formed, and is configured such that an end of a quadrangular bar 10 of a frame for steel furniture is coupled to one surface of the first horizontal bar 40 while surrounding the fastening hole 41.

Herein, a frame for steel furniture includes: a pressed slit 20 which is open in a predetermined area in two surfaces neighboring to a corner 15 of the quadrangular bar 10; a support plate 3 including a fastening hole 3a, and inserted into the pressed slit 20 to be positioned inside the quadrangular bar 10; and a fastening screw 1 inserted into the hollow quadrangular bar 10 from outside an end of the quadrangular bar 10 to be fastened to the fastening hole 3a of the support plate 3.

Therefore, the first horizontal bar 40 is provided at an end of the quadrangular bar 10, the support plate 3 is inserted into the pressed slit 20 of the quadrangular bar 10 so that the support plate 3 is provided inside the quadrangular bar 10, and the fastening screw 1 is passed through the fastening hole 41 from inside or outside the hollow first horizontal bar 40 to be fastened to the fastening hole 3a of the support plate 3 provided inside the quadrangular bar 10, whereby the frame for steel furniture and the first horizontal bar 40 can be easily coupled to each other.

Furthermore, when a fixing plate 70 of a predetermined area in which at least one fastening hole 71 is formed is coupled to the quadrangular bar 10, an end of the quadrangular bar 10 of the frame for steel furniture is connected to one surface of the fixing plate 70 while surrounding the fastening hole 71, and the fastening screw 1 is passed through (or fastened to) the fastening hole 71 of the fixing plate 70 to be inserted into the quadrangular bar 10 and fastened to the fastening hole 3a of the support plate 3, whereby the fixing plate 70 and the frame for steel furniture can be easily coupled to each other.

Furthermore, a connecting portion 72 of a predetermined area protrudes to a predetermined height from one side of the fixing plate 70 in which the fastening hole is formed such that the fastening hole 71 is formed inside the connecting portion, and an end of the quadrangular bar 10 of the frame for steel furniture is connected to one surface of the fixing plate 70 while surrounding the connecting portion 72.

The fixing plate 70 and the quadrangular bar 10 are coupled to each other by the fastening screw 1 which is passed through the fastening hole 71 of the connecting portion 72 and fastened to the fastening hole 3a of the support plate 3 provided inside the quadrangular bar 10.

The connecting portion 72 is formed to have a size conforming to the width of the quadrangular bar 10 so that an end of the quadrangular bar 10 is fixed by the connecting portion 72 when the fixing plate and the quadrangular bar 10 are coupled to each other. The connecting portion 72 is formed on one surface of the fixing plate 70, where the quadrangular bar 10 is connected, by pressing the other surface of the fixing plate 70 to a predetermined depth.

Therefore, in the present invention, by providing a plurality of quadrangular bars 10 and a plurality of first horizontal bars 40, and by assembling and fastening the bars to each other, it is possible to configure frame assemblies of various shapes.

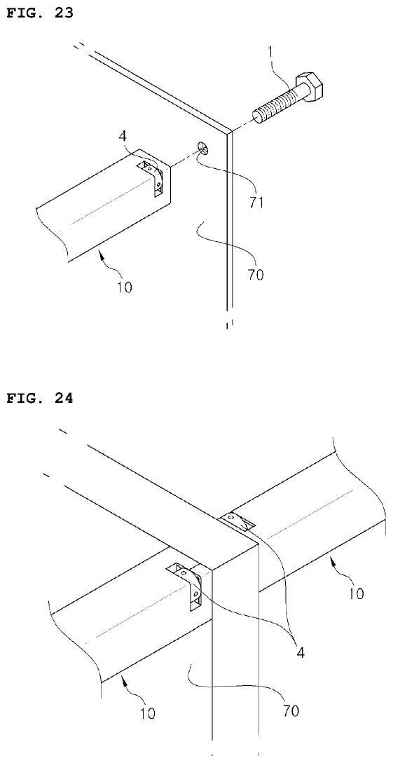

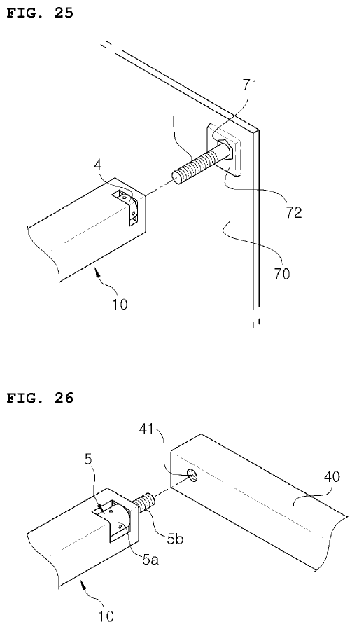

Next, FIGS. 22 to 25 are schematic views illustrating another embodiment of a frame assembly using a frame for steel furniture according to another embodiment the present invention.

A frame assembly according to an embodiment of the present invention is configured such that a first horizontal bar 40 in which at least one fastening hole 41 is formed or a fixing plate 70 in which at least one fastening hole 71 is formed is provided, and an end of a quadrangular bar 10 of a frame for steel furniture according to another embodiment of the present invention is coupled to one surface of the first horizontal bar 40 or the fixing plate 70 while surrounding the fastening hole 41 of the first horizontal bar 40 or the fastening hole 71 of the fixing plate 70.

Herein, a frame for steel furniture includes: a pressed slit 20 formed in two surfaces neighboring to a corner 15 of the quadrangular bar 10 by pressing on the corner 15 using a jig 21 having a predetermined thickness; an “L”-shaped bent bar 30 formed inside the hollow quadrangular bar 10 by formation of the pressed slit 20; a fastening ring 4 inserted into the pressed slit 20 to be positioned inside the quadrangular bar 10, supported by the bent bar 30 and the pressed slit 20 inside the quadrangular bar 10, and including a thread formed on an inner surface thereof; and a fastening screw 1 inserted into the hollow quadrangular bar 10 from outside an end of the quadrangular bar 10 to be fastened to the fastening ring 4.

Therefore, the first horizontal bar 40 is provided at an end of the quadrangular bar 10, the fastening ring 4 is inserted into the pressed slit 20 of the quadrangular bar 10 so that the fastening ring 4 is provided inside the quadrangular bar, and the fastening screw 1 is passed through the fastening hole 41 or 71 of the first horizontal bar 40 or the fixing plate 70 to be fastened to the fastening ring 4 provided inside the quadrangular bar 10, whereby the first horizontal bar 40 or the fixing plate 70 and the frame for steel furniture according to the embodiment of the present invention can be easily coupled to each other.

Furthermore, the quadrangular bar 10 may be fastened to each of opposite surfaces of the fixing plate 70 such that respective quadrangular bars correspond to each other.

Furthermore, a connecting portion 72 of a predetermined area protrudes to a predetermined height from one side of the fixing plate 70 in which the fastening hole 71 is formed such that the fastening hole 71 is formed inside the connecting portion, and an end of the quadrangular bar 10 of the frame for steel furniture is connected to one surface of the fixing plate 70 while surrounding the connecting portion 72.

The fixing plate 70 and the quadrangular bar 10 are coupled to each other by the fastening screw 1 which is passed through the fastening hole 71 of the connecting portion 72 and fastened to the fastening ring 4 provided inside the quadrangular bar 10.

Therefore, in the present invention, by providing a plurality of quadrangular bars 10 and a plurality of first horizontal bars 40, and by assembling and fastening the bars to each other, it is possible to configure frame assemblies of various shapes.

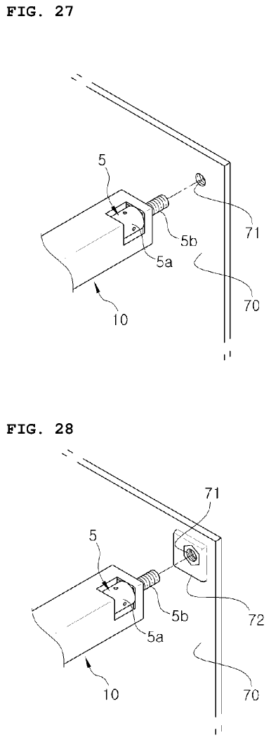

Next, FIGS. 26 to 28 are schematic views illustrating another embodiment of a frame assembly using a frame for steel furniture according to another embodiment the present invention.

A frame assembly according to an embodiment of the present invention is configured such that a first horizontal bar 40 in which at least one fastening hole 41 is formed or a fixing plate 70 in which at least one fastening hole 71 is formed is provided, and an end of a quadrangular bar 10 of a frame for steel furniture according to another embodiment of the present invention is coupled to one surface of the first horizontal bar 40 or the fixing plate 70 while surrounding the fastening hole 41 of the first horizontal bar 40 or the fastening hole 71 of the fixing plate 70.

Herein, a frame for steel furniture includes: a pressed slit 20 which is open in a predetermined area in two surfaces neighboring to at least one corner 15 of a quadrangular bar 10; and a screw 5 including a body portion 5a of a predetermined volume and a fastening portion 5b of a predetermined length provided at one side of the body portion 5a and having a thread, inserted into the pressed slit 20 to be positioned inside the quadrangular bar 10, and configured such that the fastening portion 5b is fastened to the first horizontal bar 40 while the body portion 5a is supported by the pressed slit 20.

When the first horizontal bar 40 of a predetermined length having a hollow inside or the fixing plate 70 of a predetermined area is provided at an end of the quadrangular bar 10, the screw 5 is inserted into the pressed slit 20 so that the screw 5 is positioned inside the quadrangular bar 10.

Then, the body portion 5a of the screw 5 is rotated to allow the fastening portion 5b to be fastened to the fastening hole 41 or 71 of the first horizontal bar 40 or the fixing plate 70, whereby the first horizontal bar 40 or the fixing plate 70 and the frame for steel furniture according to the embodiment of the present invention can be easily coupled to each other.

Furthermore, when the quadrangular bar 10 and the first horizontal bar or the fixing plate 70 are coupled to each other, a “U”-shaped fixing bracket 6 is inserted into and fixed to the pressed slit 20, the screw 5 is fixed to an inside of the fixing bracket 6, and the screw 5 is fastened to the first horizontal bar 40 and the fixing plate 70, whereby the frame for steel furniture according to the present invention and the first horizontal bar 40 or the fixing plate 70 can be easily coupled to each other.

Furthermore, a connecting portion 72 of a predetermined area protrudes to a predetermined height from one side of the fixing plate 70 in which the fastening hole 71 is formed such that the fastening hole 71 is formed inside the connecting portion, and an end of the quadrangular bar 10 of the frame for steel furniture is connected to one surface of the fixing plate 70 while surrounding the connecting portion 72.

The fastening portion 5b of the screw 5 is passed through the fastening hole 71 of the connecting portion 72 to be fastened to the fastening hole 71 of the fixing plate 70, whereby the fixing plate 70 and the quadrangular bar 10 are coupled to each other.

The connecting portion 72 is formed to have a size conforming to the width of the quadrangular bar 10 so that an end of the quadrangular bar 10 is fixed by the connecting portion 72 when the fixing plate and the quadrangular bar 10 are coupled to each other. The connecting portion 72 is formed on one surface of the fixing plate 70, where the quadrangular bar 10 is connected, by pressing the other surface of the fixing plate 70 to a predetermined depth, and a nut may be provided in a depression formed in the connecting portion. The fastening portion 5b of the screw 5 passing through the fixing plate 70 while being fastened to the fastening hole 71 is fastened to the nut, thereby firmly fastening the fixing plate 70 and the quadrangular bar 10 to each other.

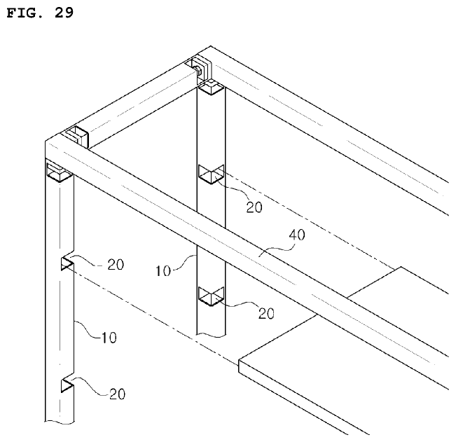

Next, FIG. 29 is an assembly view illustrating another embodiment of a frame assembly using a frame for steel furniture according to another embodiment of the present invention. A frame assembly according to the present invention may be configured such that at least two frames for steel furniture are coupled to one first horizontal bar 40. Furthermore, the frames for steel furniture may be placed on front or rear and upper or lower surfaces of the first horizontal bar 40 such that the frames cross each other. Furthermore, a plurality of quadrangular bars 10 and a plurality of first horizontal bars 40 may be coupled to each other, thereby configuring a frame assembly, such as an angle assembly. Furthermore, a plurality of pressed slits 20 may be formed in the quadrangular bar 10 and a plate of a predetermined area may be formed in the pressed slit 20, thereby easily manufacturing a shelf or the like.

### INDUSTRIAL APPLICABILITY

A frame for steel furniture and a frame assembly according to the invention are characterized in that the frame is configured by a hollow quadrangular bar 10, and a bent bar 30 having a pressed slit 20 and threads 31 is formed at the hollow quadrangular bar 10, thereby having a simple structure, and being easy to assemble using a fixing piece 60 or the like, thereby providing a significant economic benefit in that manufacturing, installation, and maintenance costs can be significantly reduced.

Furthermore, a fastening screw 1 or a height adjustment screw (not illustrated) is coupled to the bent bar 30 having the threads 31, whereby there is an advantage in that the present invention can be expanded to various embodiments, and that hollow bars of various cross-sectional shapes can also be applicable to the present invention as well as the quadrangular bar 10.

Furthermore, a nut 2 which can be fastened to a fastening screw is provided inside the quadrangular bar 10 in a space between the pressed slit 20 and the bent bar 30, whereby there is an advantage of simple and easy assembly through various embodiments.

Furthermore, a frame for steel furniture and a frame assembly according to the invention are characterized in that the frame is configured by a hollow quadrangular bar 10, a bent bar 30 having a pressed slit 20 and threads 31 is formed at the hollow quadrangular bar 10, and a fastening screw 1 and a support plate 3 are integrally inserted into the pressed slit 20 so that the fastening screw 1 inside the quadrangular bar 10 is fastened to an object to be coupled to allow the quadrangular bar 10 and the object to be coupled to be coupled to each other. Therefore, the present invention provides a simple structure, and is easy to fabricate a frame assembly, thereby providing a significant economic benefit in that manufacturing, installation, and maintenance costs can be significantly reduced.

Furthermore, a fastening ring 4 is inserted into the pressed slit 20 of the quadrangular bar 10 so that the fastening ring 4 is provided inside the quadrangular bar 10, and the object to be coupled that is connected to an end of the quadrangular bar 10 is coupled to the bar by a fastening screw 1 that is coupled to the fastening ring 4 inside the quadrangular bar 10 from outside the quadrangular bar 10. Therefore, there is an advantage in that the present invention can be expanded to various embodiments, and that hollow bars of various cross-sectional shapes can also be applicable to the present invention as well as the quadrangular bar 10.

1-25. (canceled)

26. A frame assembly for steel furniture, comprising:
A frame for steel furniture, the frame being configured by a hollow quadrangular bar, wherein a corner of the quadrangular bar is pressed by a jig having a predetermined thickness to form a pressed slit in two surfaces neighboring to the corner, and an “L”-shaped bent bar is formed inside the hollow quadrangular bar by formation of the pressed slit, and the bent bar is configured such that threads for fastening a fastening screw are formed on a surface of the bent bar, the surface facing the pressed slit;
a first horizontal bar including a fastening hole formed in each of upper and lower surfaces thereof such that the respective fastening holes face each other in up and down directions; and
a fastening screw inserted into the frame by being fastened to the fastening hole that is formed in a surface of the first horizontal bar, the surface being opposite to a surface where the frame is provided, and fastened to the bent bar formed inside the quadrangular bar of the frame so as to connect and fix the frame and the first horizontal bar to each other.

27. A frame assembly for steel furniture, comprising:
A frame for steel furniture, the frame being configured by a hollow quadrangular bar, wherein each of at least two corners of the quadrangular bar diagonally facing each other is pressed by a jig having a predetermined thickness to form a pressed slit in two surfaces neighboring to the corners, and at least two “L”-shaped bent bars are formed inside the hollow quadrangular bar by formation of the respective pressed slits, and each of the bent bars is configured such that threads for fastening a fastening screw are formed on a surface of the bent bar, the surface facing each of the pressed slits;
a first horizontal bar including a fastening hole formed in each of upper and lower surfaces thereof such that the respective fastening holes face each other in up and down directions; and
a fastening screw inserted into the frame by being fastened to the fastening hole that is formed in a surface of the first horizontal bar, the surface being opposite to a surface where the frame is provided, and fastened to the bent bar formed inside the quadrangular bar of the frame so as to connect and fix the frame and the first horizontal bar to each other.

28. A frame assembly for steel furniture, comprising:
A frame for steel furniture, the frame being configured by a hollow quadrangular bar, wherein a corner of the quadrangular bar is pressed by a jig having a predetermined thickness to form a pressed slit in two surfaces neighboring to the corner, and an “L”-shaped bent bar is formed inside the hollow quadrangular bar by formation of the pressed slit, and the bent bar is configured such that threads for fastening a fastening screw are formed on a surface of the bent bar, the surface facing the pressed slit;
a second horizontal bar provided at an end of the frame; and
a fixing piece connected to the end of the frame while surrounding an outside of the second horizontal bar, and fixing the second horizontal bar to the frame using a fastening screw that is fastened to each of opposite ends of the fixing piece and is inserted into the quadrangular bar of the frame so as to be fastened to the bent bar.

29. The frame assembly of claim 26, wherein a fastening hole is further formed in each of front and rear surfaces of the first horizontal bar such that the respective fastening holes face each other in front and rear directions.

30. The frame assembly of claim 27, wherein a fastening hole is further formed in each of front and rear surfaces of the first horizontal bar such that the respective fastening holes face each other in front and rear directions.

31. The frame assembly of claim 26, wherein at least one pressed slit and at least one bent bar are further formed above or below the pressed slit and the bent bar, respectively.

32. The frame assembly of claim 27, wherein at least one pressed slit and at least one bent bar are further formed above or below the pressed slit and the bent bar, respectively.

33. The frame assembly of claim 28, wherein at least one pressed slit and at least one bent bar are further formed above or below the pressed slit and the bent bar, respectively.

34. A frame for steel furniture, the frame being configured by a hollow quadrangular bar and comprising:
a pressed slit which is open in a predetermined area in two surfaces neighboring to a corner of the quadrangular bar; and
a screw including a body portion of a predetermined volume and a fastening portion of a predetermined length provided at one side of the body portion and having a thread, inserted into the pressed slit to be positioned inside the quadrangular bar, and configured such that the fastening portion is fastened to an object to be coupled that is connected to an end of the quadrangular bar while the body portion is supported by the pressed slit.

35. The frame of claim 34, further comprising:
a fixing bracket formed in a “U” shape so that the body portion of the screw is located therein, including a through-hole formed in a surface thereof and through which the fastening portion of the screw protrudes, and forcibly fitted into the pressed slit such that an open end thereof is supported by the pressed slit.

36. A frame assembly configured such that a first horizontal bar of a predetermined length in which at least one fastening hole is formed or a fixing plate of a predetermined area in which at least one fastening hole is formed is provided,
the end of the quadrangular bar of the frame of claim 31 is connected to one surface of the first horizontal bar or the fixing plate while surrounding the fastening hole of the first horizontal bar or the fastening hole of the fixing plate, and
the fastening screw provided inside the quadrangular bar of the frame is fastened to the fastening hole of the first horizontal bar or the fastening hole of the fixing plate, whereby the first horizontal bar or the fixing plate and the frame are coupled to each other.

37. The frame of claim 36, wherein the fixing plate further includes:
a connecting portion protruding from the fixing plate within a predetermined area that can be fitted into the end of the quadrangular bar, and in which the fastening hole is located.
